(19) United States
(12) Patent Application Publication
(10) Pub. No.: US 2010/0316890 A1
(43) Pub. Date: Dec. 16, 2010

(54) MAGNETIC TUNNEL JUNCTION DEVICE WITH MAGNETIC FREE LAYER HAVING SANDWICH STRUCTURE

(75) Inventors: Young-suk CHOI, Santa Clara, CA (US); Koji TSUNEKAWA, Tokyo (JP)

Correspondence Address: FITZPATRICK CELLA HARPER & SCINTO, 1290 Avenue of the Americas, NEW YORK, NY, 10104-3800, US

(73) Assignee: CANON ANELVA CORPORATION, Kawasaki-shi (JP)

(21) Appl. No.: 12/759,826

(22) Filed: Apr. 14, 2010

Related U.S. Application Data
(63) Continuation of application No. PCT/JP2007/070882, filed on Oct. 26, 2007.

(51) Int. Cl. G11B 5/39

(52) U.S. Cl. 428/811.1

(57) ABSTRACT

On the substrate (101), there is formed at least a laminated structure composed of sandwiching a tunnel barrier layer (107) between magnetic pinned layers (105 and 106) each having multilayer structure and magnetic free layers (108, 109, and 110) each having multilayer structure. The magnetic pinned layer having multilayer structure, the tunnel barrier layer, and the magnetic free layer having multilayer structure are stacked in this order on the substrate. The magnetic free layer having multilayer structure has a sandwich structure holding an intermediate layer (109) between a first magnetic free layer (108) and a second magnetic free layer (110). The intermediate layer comprises any one of a single-layer metal nitride, a single-layer alloy, and a multilayer film obtained by stacking pluralities of films made of metal, metal nitride, or alloy. After the formation of the laminated structure, annealing treatment is applied thereto in a magnetic field, thus providing a specified magnetization to the MTJ device (100).

### CROSS-REFERENCES TO RELATED APPLICATIONS

This application is a continuation application of International Application No. PCT/JP2007/070882, filed on Oct. 26, 2007, the entire contents of which are incorporated by reference herein.

### TECHNICAL FIELD

The present invention relates to a magnetic tunnel junction (MTJ) device applicable to magnetic head and magnetic random access memory (MRAM) used in information-storing devices such as hard disc drive.

### BACKGROUND ART

In recent years, MTJ device having tunnel barrier layer made from MgO has become a promising candidate for magnetoresistive device which can be manufactured providing high MR ratio even at room temperature (Non-Patent Document 1).

Conventional MTJ device will be explained below referring to FIG. 8. An MTJ device 810 is structured by sandwiching a tunnel barrier layer 808 between two ferromagnetic layers 807 and 809. In a state where a specific voltage is applied to these two ferromagnetic layers 807 and 809 to let a certain current flow therethrough, an external magnetic field is applied thereto. Then, there appears a characteristic as described below. When the magnetization of these two ferromagnetic layers 807 and 809 is in parallel and in the same direction with each other, (hereinafter referred to as the “parallel state”), the electric resistance of the MTJ device becomes minimum, (the state of FIG. 8(A)), (hereinafter the resistance in this state is defined as Rn). When the magnetization of these two ferromagnetic layers 807 and 809 is in parallel and in the opposite direction from each other, (hereinafter referred to as the “antiparallel state”), the electric resistance of the MTJ device becomes maximum, (the state of FIG. 8(B)), (hereinafter the resistance in this state is defined as R_{A}). Accordingly, the MTJ device 810 can store information in a form of variations in resistances by creating the parallel state and the antiparallel state depending on the applied external magnetic field.

That type of MTJ device is required to have a large difference between the resistance R_{P} in the “parallel state” and the resistance R_{A} in the “antiparallel state”. As an index of the difference, the magnetoresistance ratio (MR ratio) is used. The MR ratio is defined as [(R_{A}−R_{P})/R_{P}].

To obtain high MR ratio, there are proposed several technologies, such as the one in which the ferromagnetic layer 809 is formed as magnetic free layer through the use of amorphous CoFeB, and the one in which the tunnel barrier layer 808 made from MgO is formed by the RF sputtering method. Those technologies have allowed the mass production of magnetic heads used in high-density media such as hard disc drive (HDD) and MRAM.

However, CoFeB has a strong coercive force (Hc) inherent to the strong crystallinity. As a result, in forming the magnetic free layer by utilizing CoFeB, it is necessary even for the magnetic head to improve the recording performance required by the devices thereof, or to increase the intensity of memory magnetic field similar to the case of MRAM. Consequently, the realization of a magnetic free layer having low coercive force is required.

It is known that the output ΔV generated from magnetic head is indicated by the following formula:

ΔV=a×I×ΔRₓ×(T_{w}/Tₕ)×Φ/(M_{f}×t) (1)

where
a: constant
I: current
ΔRₛ: variations in resistance
T_{w}: width of track
Tₕ: height of track
Φ: flux density
M_{f}: saturated magnetization in the magnetic free layer
t: thickness of the magnetic free layer

As shown in eq. (1), in order to increase the output of the magnetic head, there is required the realization of a magnetic free layer having small value of the product of the saturated magnetization (M_{f}) and the thickness (t), (M_{f}×t).

Recently, there are proposed MTJ devices in which the magnetic free layer is formed by a single-layer structure, two-layer structure composed of two magnetic free layers having different materials from each other, and three-layer structure in which the two magnetic free layers are separated from each other by a metallic intermediate layer (Patent Document 1).

FIG. 9 illustrates the structure of a conventional MTJ device having a single layer of magnetic free layer 908. An MTJ device 900 in FIG. 9 includes a substrate 901, an underlayer 902, an antiferromagnetic layer 903, a first magnetic pinned layer 904, a non-magnetization layer for exchange coupling 905, a second magnetic pinned layer 906, a tunnel barrier layer 907, the magnetic free layer 908, and an electrode layer 911.

FIG. 10 illustrates the structure of a conventional MTJ device containing two magnetic free layers 1008 and 1010 having different materials from each other. An MTJ device 1000 in FIG. 10 includes a substrate 1001, an underlayer 1002, an antiferromagnetic layer 1003, a first magnetic pinned layer 1004, a non-magnetization layer for exchange coupling 1005, a second magnetic pinned layer 1006, a tunnel barrier layer 1007, the first magnetic free layer 1008, the second magnetic free layer 1010, and an electrode layer 1011.

FIG. 11 illustrates the structure of a conventional MTJ device having a three-layer structure separating two magnetic free layers 1108 and 1110 from each other by a metallic intermediate layer 1109. An MTJ device 1100 in FIG. 11 includes a substrate 1101, an underlayer 1102, an antiferromagnetic layer 1103, a first magnetic pinned layer 1104, a non-magnetization layer for exchange coupling 1105, a second magnetic pinned layer 1106, a tunnel barrier layer 1107, the first magnetic free layer 1108, the intermediate layer 1109, the second magnetic free layer 1110, and an electrode layer 1111.

There is also proposed that the use of a magnetic free layer having two-layer structure of CoFeB/NiFe or the use of a magnetization layer in multilayer structure can reduce the coercive force Hc of the magnetic free layer (Non-Patent Documents 2 and 4).

There is also reported a magnetic free layer made from CoFeB having coercive force (Hc) of about 30 Oersted (Oe) (Non-Patent Documents 2 and 3).

### [Patent Document 1] Japanese Patent Application Laid-Open Publication No. 206-319259

### [Non-Patent Document 1] Physical Review B, Vol. 63, pp. 054416, 2001

### [Non-Patent Document 2] Fujitsu Science and Technology Journal, Vol. 42, pp. 139, 2006

### [Non-Patent Document 3] Applied Physics Letter, Vol. 88, pp. 182508, 2006

[Non-Patent Document 4] 29th Japan Applied Magnetic Society Symposium, 22aF-8, 2005

### [Non-Patent Document 5] Applied Physics Letter, Vol. 87, pp. 242503, 2005

### [Non-Patent Document 6] Journal of Applied Physics, Vol. 101, pp. 103907, 2007

### DISCLOSURE OF THE INVENTION

### Problems to be Solved by the Invention

The values of coercive force of the magnetic free layer provided in the related art, however, are not sufficient to apply to the magnetic head used in HDD having larger storing density than ever. Therefore, further reduction in the coercive force is desired. In addition, there arises a problem of significant decrease in the MR ratio of MTJ device if the coercive force is further reduced.

An object of the present invention is to provide an MTJ device having a structure which reduces the coercive force of the magnetic free layer without decreasing the MR ratio, and has small value of the product of the saturated magnetization (Mf) in the magnetic free layer and the thickness (t) therein, (Mf×t).

### Means to Solve the Problems

To solve the above problems, the MTJ device of the present invention is structured so as a substrate to have at least a laminated structure thereon, the laminated structure being formed by sandwiching a tunnel barrier layer between a magnetic pinned layer having multilayer structure and a magnetic free layer having multilayer structure. The magnetic pinned layer having multilayer structure, the tunnel barrier layer, and the magnetic free layer having multilayer structure are stacked in this order on the substrate. The magnetic free layer having multilayer structure has a sandwich structure holding an intermediate layer between a first magnetic free layer and a second magnetic free layer. The intermediate layer comprises any one of a single-layer of metal nitride, a single-layer of alloy, or a multilayer film stacking pluralities of films made of metal, metal nitride, or alloy. A specified magnetization is provided to the MTJ device by applying annealing treatment after forming the laminated structure in a magnetic field.

In the present invention, the magnetic free layer having multilayer structure can be formed by stacking the first magnetic free layer, the intermediate layer, and the second magnetic free layer, in this order on the substrate.

The magnetic pinned layer having multilayer structure is characterized by being formed by stacking the first magnetic pinned layer, the non-magnetization layer for exchange coupling, and the second magnetic fixed layer in this order on the substrate.

The metal nitride described above is one of TiNx, HfNx, NbNx, TaNx, VNx, CrNx, ZrNx, NoNx, and WNx. The alloy described above contains at least two of Ta, Nb, Zr, W, Mo, Hf, Ti, V, and Cr.

Furthermore, the multilayer film can be configured as a multilayer structure being formed by stacking pluralities of films composed of Ta, Nb, Zr, W, Mo, Ti, V, Cr, a nitride thereof, or an alloy thereof.

The tunnel barrier layer can be formed as an MgO layer, and the MgO layer is characterized by having a polycrystalline structure having (001) orientation vertical to the film surface.

Furthermore, the first magnetic free layer can be made from CoFeB, and the second magnetic free layer can be made from NiFe which has a coercive force smaller than that of the first magnetic free layer.

The condition of annealing treatment is preferably: 250° C. to 400° C. of annealing temperature; 0.5 to 10 hours of holding the annealing temperature; and 8 kOe or larger intensity of magnetic field parallel to the film surface, applied during annealing.

According to the present invention, 5 Oe or smaller coercive force is attained in the magnetic free layer of the magnetic tunnel junction device after the annealing treatment. Simultaneously, 150% or larger MR ratio is attained in the magnetic tunnel junction device after the annealing treatment.

According to the present invention, the product of the saturated magnetization and the thickness of the magnetic free layer of the magnetic tunnel junction device after the annealing treatment becomes 75 Gμm or smaller, and thus when the MTJ device of the present invention is applied to a magnetic head, the output of the magnetic head can be increased.

### EFFECT OF THE INVENTION

According to the present invention, there can be realized an MTJ device which significantly reduces the coercive force of the magnetic free layer and provides small value of the product of saturated magnetization of the magnetic free layer and the thickness thereof without decreasing the MR ratio, in which MTJ device the magnetic free layer having multilayer structure is configured as a sandwiching structure holding the intermediate layer between the first magnetic free layer and the second magnetic free layer, and the material of the intermediate layer is configured from any one of metal nitride, alloy, and multilayer film. The MTJ device of the present invention can be effectively applied to the future magnetic heads and MRAMs.

### BRIEF DESCRIPTION OF THE DRAWINGS

FIG. 1 illustrates the structure of an MTJ device in which the first magnetic free layer and the second magnetic free layer are separated from each other by an intermediate layer made from a metal nitride, in the first example of the present invention.

FIG. 2 shows the relation between the thickness and the coercive force of the second magnetic free layer NiFe in the first example of the present invention.

FIG. 3 shows the relation between the thickness and the MR ratio of the second magnetic free layer NiFe in the first example of the present invention.

FIG. 4 shows the relation between the thickness and the coercive force of the intermediate layer made from metal nitride TiN in the first example of the present invention.

FIG. 5 shows the relation between the thickness and the MR ratio of the intermediate layer made from metal nitride TiN in the first example of the present invention.

FIG. 6 illustrates the structure of an MTJ device in which the first magnetic free layer and the second magnetic free layer are separated from each other by an intermediate layer made of an alloy, in the second example of the present invention.

FIG. 7 illustrates the structure of an MTJ device in which the first magnetic free layer and the second magnetic free layer are separated from each other by an intermediate layer structured by a multilayer film, in the third example of the present invention.

FIG. 8 illustrates the operation of the MTJ device.

FIG. 9 illustrates the structure of an MTJ device having a single-layer of magnetic free layer according to the related art.

FIG. 10 illustrates the structure of an MTJ device in which the first magnetic free layer and the second magnetic free layer are directly stacked together to form a two-layer structure according to the related art.

FIG. 11 illustrates the structure of an MTJ device in which the first magnetic free layer and the second magnetic free layer are separated from each other by an intermediate layer made of a metal to form a three-layer structure according to the related art.

Description of the Reference Numerals
101, 601, 701, 901, 1001, 1101 Substrate
102, 602, 702, 902, 1002, 1102 Underlayer
103, 603, 703, 903, 1003, 1103 Antiferromagnetic layer
104, 604, 704, 904, 1004, 1104 First magnetic pinned layer
105, 605, 705, 905, 1005, 1105 Non-magnetization layer for exchange coupling
106, 606, 706, 906, 1006, 1106 Second magnetic pinned layer
107, 607, 707, 907, 1007, 1107 Tunnel barrier layer
108, 608, 708, 1008, 1108 First magnetic free layer
908 Magnetic free layer
109, 609, 709, 709′, 1109 Intermediate layer
110, 610, 710, 1010, 1110 Second magnetic free layer
111, 611, 711, 911, 1011, 1111 Electrode layer

### BEST MODE FOR CARRYING OUT THE INVENTION

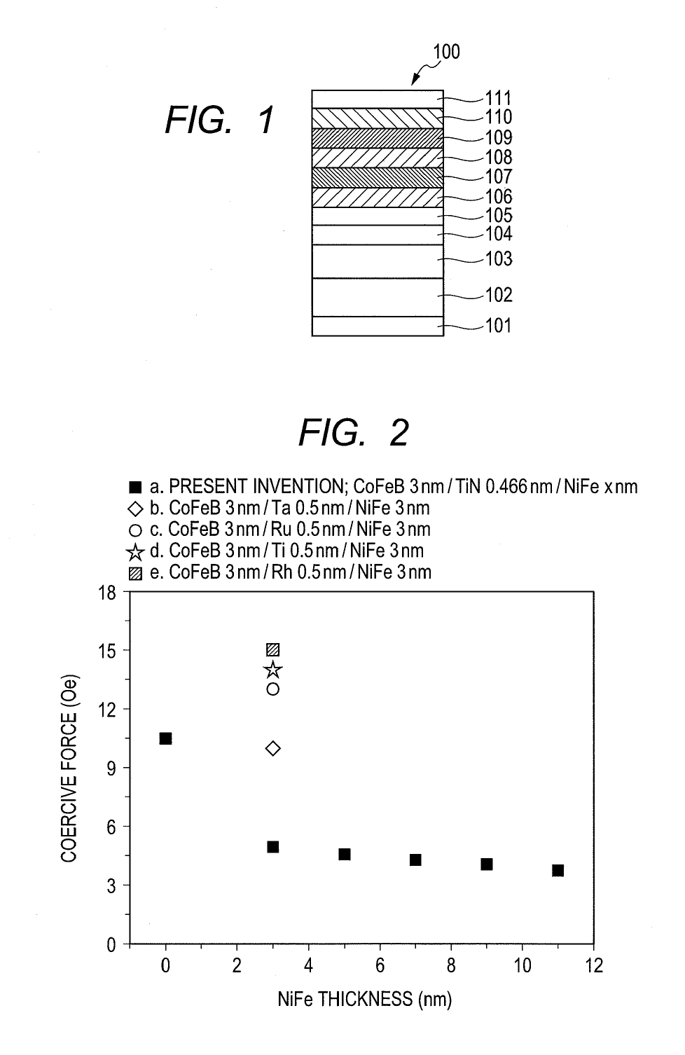

The structure of the MTJ device of the present invention will be described below. FIG. 1 illustrates the structure of preferred first embodiment of the MTJ device of the present invention. In forming the MTJ device 100 of the present invention, the substrate 101 is etched by the plasma treatment in order to remove impurities on the surface thereof. Then, on the substrate 101, there are stacked the underlayer 102 (having multilayer structure of Ta: 5 nm/CuN: 20 nm/Ta: 3 nm/CuN: 20 nm/Ru: 5 nm, the numeral signifies an example of thickness there each), the antiferromagnetic layer 103 (IrMn: 7 nm), the first magnetic pinned layer 104 (Co₇₀Fe₃₀: 2.5 nm), the non-magnetization layer for exchange coupling 105 (Ru: 0.85 nm), the second magnetic pinned layer 106 (CoFeB: 3 nm), the tunnel barrier layer 107 (MgO: 1.2 nm), the first magnetic free layer 108 (CoFeB), the intermediate layer 109 (TiN), the second magnetic free layer 110 (Ni₈₁Fe₁₉), and the electrode layer 111 (multilayer structure of Ta/Cu/Ta/Ru) in this order. The first magnetic pinned layer 104, the non-magnetization layer for exchange coupling 105, and the second magnetic pinned layer 106 form a magnetic pinned layer having multilayer structure. The first magnetic free layer 108, the intermediate layer 109, and the second magnetic free layer 110 form a magnetic free layer having multilayer structure.

The terms “magnetic free layer” and “magnetic pinned layer” are defined as those having the magnetic moment in the magnetic free layer smaller than the magnetic moment in the magnetic pinned layer. The substrate in which thus MTJ device has been formed is transferred through a high vacuum annealing apparatus. An example of the annealing condition is: 8 kOe or larger intensity of magnetic field parallel to the film surface, applied during annealing; 250° C. to 400° C. (for example, 360° C.) of annealing temperature; and 0.5 to 10 hours (for example, 2 hours) of holding the annealing temperature. The annealing treatment provides a desired magnetization to the MTJ device.

The MTJ device of the present invention makes use of NiFe as the second magnetic free layer 110. The MTJ device of the example has an advantage of reducing the coercive force because NiFe is a soft magnetic material giving lower coercive force than that of the first magnetic free layer 108, conducts magnetic coupling with the first magnetic free layer 108 via the intermediate layer 109, and generates soft magnetic property in the first magnetic free layer 108.

The tunnel barrier layer 107 (MgO) preferably has a polycrystalline structure having (001) orientation vertical to the film surface, and both the second magnetic pinned layer 106 and the first magnetic free layer 108 are preferably made from CoFeB and are preferably in amorphous state in the stacked state. It is known that the tunnel barrier layer 107 with (001) orientation, having NaCl structure and contacting with amorphous CoFeB plays a role of template for crystallization of bcc CoFe during annealing treatment, (refer to Non-Patent Document 5). That is, the annealing treatment after stacking the MTJ device carries out crystallization by using MgO(001)[100], which is the tunnel barrier layer 107, as the template, on which bcc CoFe(001)[110] is rotated by 45°. This is because the presence of epitaxial relation of bcc CoFe(001)[110]//MgO(001)[100]. The crystallization obtained by 45° rotation forms pillar shape particles of CoFe/MgO/CoFe, and each particle has a micro-structure essential to achieve the giant tunnel magnetoresistive effect (refer to Non-Patent Document 6).

The material of the intermediate layer 109 in the magnetic free layer in the sandwich structure is determined by the crystal structure of the material, and is preferably in amorphous state or in an NaCl structure having (001) orientation as in the crystal structure of the first magnetic free layer 108 (CoFeB) having (001) orientation. The example makes use of TiN as the material of the intermediate layer 109. Other than that, however, the intermediate layer 109 may be formed by using metal nitrides such as TiNx, HfNx, NbNx, TaNx, VNx, CrNx, ZrNx, MoNx, and WNx. In addition, the intermediate layer 109 (TiN) in the example is stacked by the reactive sputtering method.

The relative thickness of each layer in the magnetic free layer of sandwich structure is determined by the coercive force and the MR ratio required to the MTJ device. The following is the description about the characteristics of coercive force and MR ratio of the MTJ device of the example.

FIG. 2 shows the relation between the structure and the coercive force of the magnetic free layer in the sandwich structure. The parameter “a” in FIG. 2 shows the relation between the thickness and the coercive force of the second magnetic free layer 110 (NiFe) in the magnetic free layer having sandwich structure of the CoFeB (the first magnetic free layer 108, 3 nm in thickness)/TiN (the intermediate layer 109, 0.466 nm in thickness)/NiFe (the second magnetic free layer 110, ×nm in thickness) of the present invention. It can be seen that the structure of the present invention significantly reduces the coercive force to 4.5 Oersted (Oe) or less when the thickness of the second magnetic free layer 110 (NiFe) is 3 nm or more. On the other hand, the parameters “b” to “e” in FIG. 2 show the coercive force in the structure of using the first magnetic free layer made from CoFeB having a thickness of 3 nm, the intermediate layer composed of Ta, Ru, Ti, or Rh, having a thickness of 0.5 nm, and the second magnetic free layer made from NiFe having a thickness of 3 nm, which is disclosed in Patent Document 1.

In the MTJ device 1100 of the related art shown in FIG. 11, when Ta is used as the intermediate layer 1109, and the first magnetic free layer 1108, the intermediate layer 1109, and the second magnetic free layer 1110 are formed into a structure of CoFeB/Ta/NiFe, the coercive force Hc does not vary.

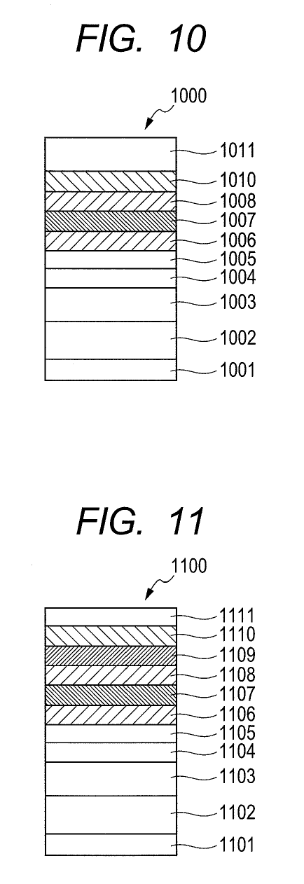

In the MTJ device 1000 of the related art shown in FIG. 10, when there was formed a magnetic free layer including the first magnetic free layer 1008 made from CoFeB and the second magnetic free layer 1010 made from NiFe, without using the intermediate layer, the coercive force Hc became 4 Oe. However, when the coercive force was reduced from 21 Oe in the magnetic free layer structured by a single layer of CoFeB (3 nm) to 4 Oe in the magnetic free layer structured by two-layers of CoFeB (2 nm)/NiFe (3 nm), the MR ratio considerably decreased from 120% to 60%.

The significant decrease in the coercive force in the present invention is larger than that in the cases of the related art shown in FIG. 11 and FIG. 10. In this example, when the thickness of the second magnetic free layer 110 (NiFe) is larger than 3 nm, it is presumed that the magnetic coupling with the first magnetic free layer 108 (CoFeB) via the intermediate layer 109 (TiN) becomes strong, which causes the soft magnetic property of CoFeB and thus, the magnetization of CoFeB decreases As shown in FIG. 2, the coercive force monotonously decreases with the increase in the thickness of the second magnetic free layer 110 (NiFe), and when the thickness of the second magnetic free layer 110 (NiFe) becomes 11 nm, the coercive force reaches 4 Oe. As is clear from FIG. 2, the value of the coercive force is smaller than that in the magnetic free layer having the structure described in Patent Document 1.

Regarding the magnetic free layer of the sandwich structure of the present invention (CoFeB (3 nm)/TiN (0.466 nm)/NiFe (3 nm)), the product of the saturated magnetism and the thickness of the magnetic free layer is 75 Gμm or less. From FIG. 2, however, it can be seen that the coercive force of 5 Oe or less is simultaneously realized.

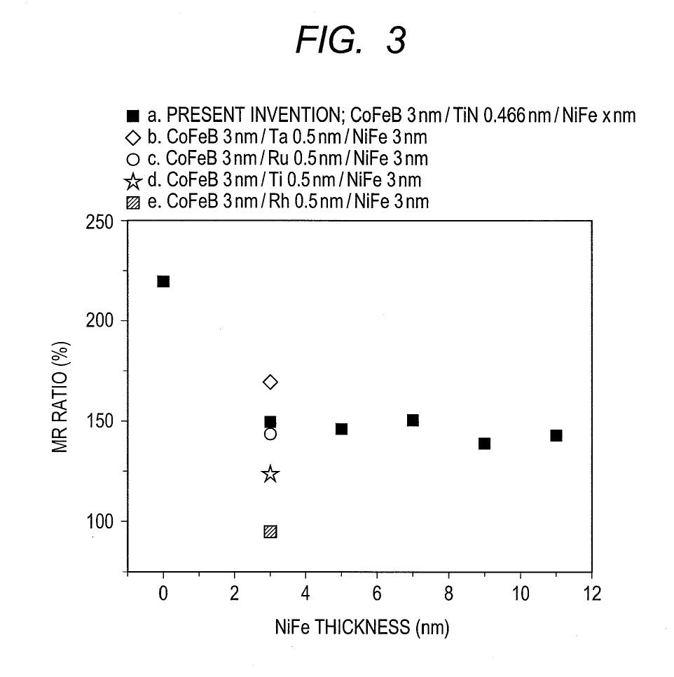

Next, FIG. 3 shows the relation between the structure and the MR ratio of the magnetic free layer having the sandwich structure. The parameter “a” in FIG. 3 shows the relation between the thickness and the MR ratio of the second magnetic free layer 110 (NiFe) in the magnetic free layer having the sandwich structure of the present invention (CoFeB (3 nm)/TiN (0.466 nm)/NiFe (×nm)). When the thickness of the second magnetic free layer 110 (NiFe) is 3 nm or larger, the MR ratio decreases from 220% to 150%, and then is saturated. For the second magnetic free layer 110 (NiFe) with a thickness of 3 nm or more in the magnetic free layer having the sandwich structure shown in the example, the standard MR ratio is 150%.

On the other hand, the parameters “b” to “e” in FIG. 3 show, in the same way as those in FIG. 2, the MR ratio in the structure using the first magnetic free layer made from CoFeB, having a thickness of 3 nm, the intermediate layer composed of Ta, Ru, Ti, or Rh, having a thickness of 0.5 nm, and the second magnetic free layer made from NiFe, having a thickness of 3 nm, as disclosed in Patent Document 1. As shown in FIG. 3, only “b” in which Ta as the intermediate layer was used gives higher MR ratio than that of the structure of the example, while the MR ratio of “c” to “e” is smaller than that of the example. Furthermore, as is clear from FIG. 2, the coercive force in the structure utilizing Ta as the intermediate layer is much greater than that in the example.

Consequently, the sandwich structure of the present invention, (CoFeB (3 nm)/TiN (0.466 nm)/NiFe (3 nm)), has achieved both the reduction in the coercive force and the ensuring of high MR ratio of the magnetic free layer. As described above, the product of the saturated magnetism of the magnetic free layer and the thickness thereof in the MTJ device of the present invention is 75 Gμm or less, and at the same time, 5 Oe or smaller coercive force and 150% or larger MR ratio of the magnetic free layer are realized.

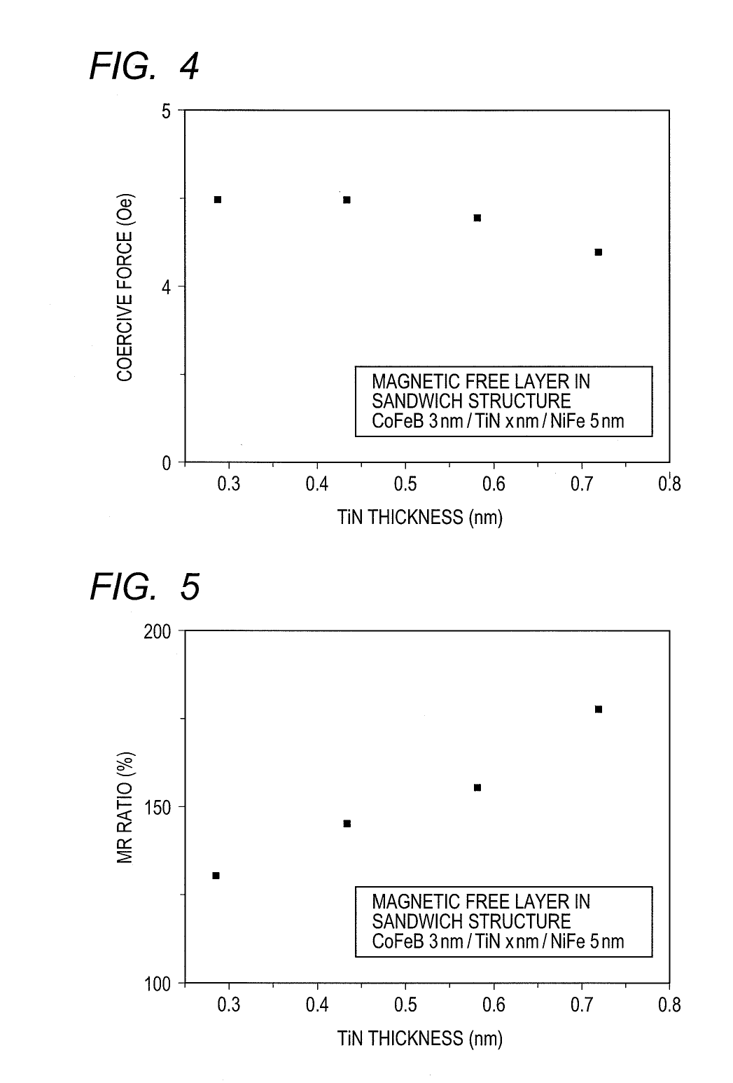

FIG. 4 shows the relation between the thickness and the coercive force in the intermediate layer 109 made from metal nitride TiN in the magnetic free layer having the sandwich structure of the present invention, (CoFeB (3 nm)/TiN (×nm)/NiFe (5 nm)). When the thickness of the intermediate layer 109 was varied from 0.286 nm to 0.719 nm, the coercive force slightly decreased from 4.5 Oe to 4.2 Oe. FIG. 5 shows the relation between the thickness and the MR ratio of the intermediate layer 109 made from metal nitride TiN in the magnetic free layer having the sandwich structure of the present invention (CoFeB (3 nm)/TiN (×nm)/NiFe (5 nm)). When the thickness of the intermediate layer 109 was varied from 0.286 nm to 0.719 nm, the MR ratio increased from 130% to 180%.

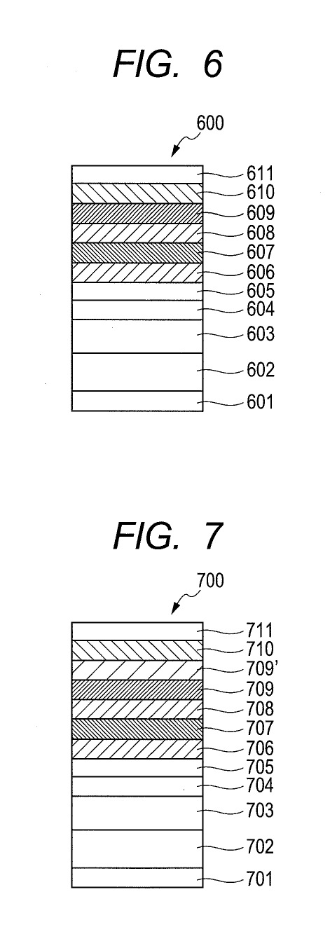

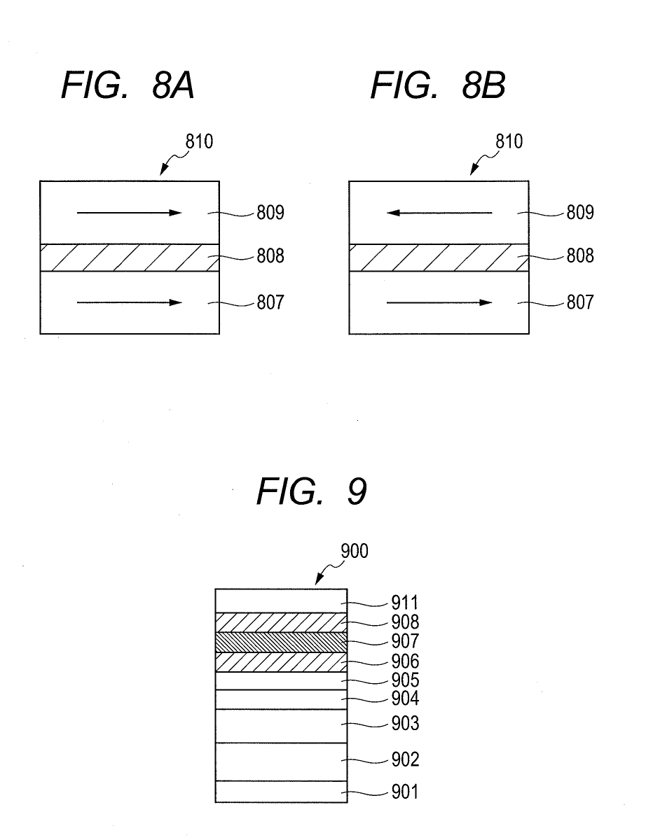

FIG. 6 illustrates the structure of preferred second embodiment of the MTJ device of the present invention. Unlike the first embodiment given in FIG. 1, the intermediate layer 609 is made of an alloy, not a metal nitride. For example, the intermediate layer 609 makes use of an alloy containing at least two of Ta, Nb, Zr, W, Mo, Hf, Ti, V, and Cr. In the same way as in the case of the metal nitride film in the first embodiment, the example causes magnetic coupling between the first magnetic free layer and the second magnetic free layer, thus providing an effect of reducing the coercive force.

FIG. 7 illustrates the structure of preferred third embodiment of the MTJ device of the present invention. Unlike the first embodiment shown in FIG. 1, the intermediate layer is not made of a single layer of metal nitride, but structured by a multilayer film containing at least two layers of the first intermediate layer 709 and the second intermediate layer 709′. For example, the intermediate layer makes use of a multilayer film including pluralities of films composed of a metal selected from the group consisting of Ta, Nb, Zr, W, Mo, Ti, V, and Cr, or a multilayer film including pluralities of films composed of nitride thereof, or a multilayer film including pluralities of films made of alloy thereof. In the same way as in the case of the metal nitride film in the first embodiment, the example causes magnetic coupling between the first magnetic free layer and the second magnetic free layer, thus providing an effect of reducing the coercive force.

1. A magnetic tunnel junction device comprising a substrate and a laminated structure on the substrate, the laminated structure having a tunnel barrier layer being sandwiched between a magnetic pinned layer of a multilayer structure and a magnetic free layer of a multilayer structure,
wherein the tunnel barrier layer is a MgO layer,
the magnetic free layer of the multilayer structure comprises a first magnetic free layer of CoFeB, a second magnetic free layer of NiFe and an intermediate layer sandwiched between the first and second free layers,
the intermediate layer is a single layer film comprising nitride of metal selected from a metal group of Ta, Nb, Zr, W, Mo, Ti, V and Cr or a multilayer film laminated by a plurality of layers each of which comprises nitride of metal selected from said metal group, and
the magnetizations of the magnetic pinned layer and the magnetic free layer are produced by annealing the laminated structure in a magnetic field.

2. The magnetic tunnel junction device according to claim 1, wherein a coercive force in the magnetic free layer is equal to or less than 5 Oe and MR ratio is equal to or larger than 150%.

3. The magnetic tunnel junction device according to claim 1, wherein the MgO tunnel barrier layer has a polycrystalline structure having (001) orientation vertical to the surface thereof.

4. The magnetic tunnel junction device according to claim 1, wherein the second magnetic free layer is a NiFe layer the thickness of which is equal to or larger than 3 nm.

5. A magnetic tunnel junction device according to claim 1, wherein the alloy contains at least two of Ta, Nb, Zr, W, Mo, Hf, Ti, V, and Cr.

6. A magnetic tunnel junction device according to claim 1, wherein the multilayer film has a multilayer structure being formed by stacking pluralities of films composed of Ta, Nb, Zr, W, Mo, Ti, V, Cr, a nitride thereof, or an alloy thereof.

7. A magnetic tunnel junction device according to claim 1, wherein the tunnel barrier layer is a MgO layer.

8. A magnetic tunnel junction device according to claim 7, wherein the MgO layer has a polycrystalline structure having (001) orientation vertical to the film surface.

9. A magnetic tunnel junction device according to claim 1, wherein the first magnetic free layer is composed of CoFeB.

10. A magnetic tunnel junction device according to claim 1, wherein the second magnetic free layer is composed of NiFe having a coercive force smaller than that of the first magnetic free layer.

11. A magnetic tunnel junction device according to claim 1, wherein the condition of annealing treatment is 250° C. to 400° C. of annealing temperature; 0.5 to 10 hours of holding the annealing temperature; and 8 kOe or larger intensity of magnetic field parallel to the film surface, applied during annealing.

12. A magnetic tunnel junction device according to claim 11, wherein the coercive force of the magnetic free layer of the magnetic tunnel junction device after the annealing treatment is 5 Oe or less.

13. A magnetic tunnel junction device according to claim 11, wherein the MR ratio of the magnetic tunnel junction device after the annealing treatment is 150% or more.

14. A magnetic tunnel junction device according to claim 11, wherein the product of the saturated magnetization and the thickness of the magnetic free layer of the magnetic tunnel junction device after the annealing treatment is 75 Gμm or less.
